(19) United States
(12) Patent Application Publication
(10) Pub. No.: US 2020/0261317 A1
(43) Pub. Date: Aug. 20, 2020

(54) DUAL VIAL ADAPTER ASSEMBLAGES INCLUDING TWIN VENTED FEMALE VIAL ADAPTERS

(71) Applicant: West Pharma. Services IL, Ltd., Ra'anana (IL)

(72) Inventors: Igor DENENBURG, Gedera (IL); Amir LEV, Kfar Saba (IL); Uri DAVID, Nes Ziona (IL)

(21) Appl. No.: 16/651,560

(22) PCT Filed: Sep. 20, 2018
(86) PCT No.: PCT/IL2018/051061

§ 371 Date: Mar. 27, 2020

(30) Foreign Application Priority Data
Sep. 29, 2017 (IL) 254802

(51) Int. Cl. A61J 1/20; A61J 1/14

(52) U.S. Cl. CPC A61J 1/2096; A61J 1/2082; A61J 1/1406; A61J 1/2048; A61J 1/2013; A61J 1/2041

(57) ABSTRACT

Dual vial adapter assemblages having a triple component construction as follows: a first vented female vial adapter for telescopic mounting on a drug vial, a second vented female vial adapter for telescopic mounting on a liquid vial and a tubular liquid transfer coupler for coupling the first vented female vial adapter and the second vented female vial adapter for establishing a dual sealed lumen arrangement therebetween. The dual sealed lumen arrangement includes a central sealed liquid lumen for gravitational flow of liquid contents from a liquid vial to a drug vial and a sealed air lumen radial outward from the central sealed liquid lumen for venting air displaced from the drug vial to the liquid vial for assisting the gravitational flow of liquid contents by creating a closed system between the liquid vial and the drug vial.

### FIELD OF THE INVENTION

The invention relates to dual vial adapter assemblages for use with a drug vial containing a medicament and a liquid vial containing liquid contents.

### BACKGROUND OF THE INVENTION

Dual vial adapter assemblages for use with a drug vial containing a medicament and a liquid vial containing liquid contents for mixing with or reconstituting the medicament in the drug vial to form a liquid drug include a drug vial adapter for telescopic mounting on the drug vial for puncturing same and a liquid vial adapter for telescopic mounting on the liquid vial for puncturing same. Dual vial adapter assemblages can be generally classified into two types as follows: A negative pressure type intended to be used with a drug vial under negative pressure for positively drawing liquid contents from a liquid vial thereinto. A gravitational flow type employing a venting arrangement for gravitational flow of liquid contents from a liquid vial to a drug vial. The former type requires initial telescopic mounting on a liquid vial and subsequent telescopic mounting on a drug vial and is generally intended for preparing a small liquid drug dosage. The latter type does not require a specific order of telescopic mounting on a liquid vial and a drug vial and is generally intended for preparing a large liquid drug volume suitable for aspiration of several liquid drug dosages or use with an IV set for infusion.

One exemplary dual vial adapter assemblage of the gravitational type is disclosed in commonly owned U.S. Pat. No. 8,752,598 to Denenburg et al. entitled Liquid Drug Transfer Assembly. U.S. Pat. No. '598 FIG. 9 shows a dual vial adapter assemblage including a drug vial adapter having a female connector and a liquid vial adapter having a dual lumen dual ended liquid transfer spike for puncturing both a liquid vial stopper and a drug vial stopper. A user has to correctly distinguish between the drug vial adapter and the liquid vial adapter such that liquid drug is formed in the drug vial thereby enabling attachment of a needleless syringe to the drug vial adapter for aspiration of liquid drug therefrom. However, the drug vial adapter and the liquid vial adapter have a high degree of resemblance which can lead to confusion therebetween which in turn can lead to the liquid drug being formed in the liquid vial thereby precluding attachment of a needleless syringe to the liquid vial adapter having the dual lumen dual ended liquid transfer spike.

Additional dual vial adapter assemblages are disclosed in commonly owned PCT International Application No. PCT/IL2017/050527 entitled Dual Vial Adapter Assemblages including Vented Drug Vial Adapter and Vented Liquid Vial Adapter and published under PCT International Publication No. WO 2017/203512 as follows: FIG. 1 to FIG. 5 disclose a vented female drug vial adapter and a vented male liquid vial adapter; FIG. 6 to FIG. 8 disclose identical dual vented female vial adapters and an intermediate dual ended liquid transfer coupler having an opposite pair of male connectors. FIG. 9 to FIG. 11 disclose identical dual vented male vial adapters and an intermediate dual ended liquid transfer coupler having an opposite pair of female connectors. The dual vial adapter assemblages with identical dual vented vial adapters afford the advantage that the vented vial adapters can be equally telescopically mounted on a drug vial or a liquid vial thereby precluding the need for a user to distinguish between a drug vial adapter and a liquid vial adapter. The vented vial adapters are preferably designed for quick release from a vial as disclosed in PCT International Publication No. WO 2012/150587 entitled Vial Adaptor. Accordingly, a vented vial adapter can be readily removed from a drug vial containing a liquid drug thereby exposing its drug vial stopper for insertion of an IV set for infusion of the liquid drug to a patient.

There is a need for dual vial adapter assemblages for improved gravitational flow from a liquid vial to a drug vial for forming liquid drug contents in the drug vial.

### SUMMARY OF THE INVENTION

The present invention is directed towards dual vial adapter assemblages having a triple component construction as follows: a first vented female vial adapter for telescopic mounting on a drug vial, a second vented female vial adapter for telescopic mounting on a liquid vial and a tubular liquid transfer coupler for coupling the first vented female vial adapter and the second vented female vial adapter for establishing a dual sealed lumen arrangement therebetween. The dual sealed lumen arrangement includes a central sealed liquid lumen for gravitational flow of liquid contents from a liquid vial to a drug vial on disposing the former above the latter and at least one sealed air lumen radial outward from the central sealed liquid lumen for venting air displaced from the drug vial to the liquid vial for assisting the gravitational flow of liquid contents by creating a closed system between the liquid vial and the drug vial. The liquid transfer coupler is preferably designed such that a sealed air lumen preferably surrounds a central sealed liquid lumen and is concentric therewith. The dual vial adapter assemblages of the present invention are preferably provided in a set-up position ready for immediate use on removal from suitable sterile packaging. Alternatively, the dual vial adapter assemblages may require assembly by a user before use.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a pictorial view of an administration set including a needleless syringe, a drug vial, a liquid vial, an infusion set, and a dual vial adapter assemblage in accordance with a first preferred embodiment of the present invention;

FIG. 2 is an exploded view of the FIG. 1 dual vial adapter assemblage;

FIG. 3 is a longitudinal cross section of the FIG. 1 dual vial adapter assemblage along line A-A in FIG. 1;

FIG. 4 is a longitudinal cross section of the FIG. 1 dual vial adapter assemblage along line A-A in FIG. 1 showing transfer of liquid contents from a liquid vial to a drug vial and venting of air displaced from the drug vial to the liquid vial;

FIG. 5A to FIG. 5F show the use of the administration set;

FIG. 6 is a perspective view of a dual vial adapter assemblage in accordance with a second preferred embodiment of the present invention;

FIG. 7 is an exploded view of the FIG. 6 dual vial adapter assemblage;

FIG. 8A is a top view of a liquid transfer coupler of the FIG. 6 dual vial adapter assemblage;

FIG. 8B is a longitudinal cross section view of the FIG. 6 liquid transfer coupler along line C-C in FIG. 8A;

FIG. 8C is a longitudinal cross section of the FIG. 6 liquid transfer coupler along line D-D in FIG. 8A; and

FIG. 9 is a longitudinal cross section of the FIG. 6 dual vial adapter assemblage along line D-D in FIG. 8A.

### DETAILED DESCRIPTION OF PREFERRED EMBODIMENTS OF THE INVENTION

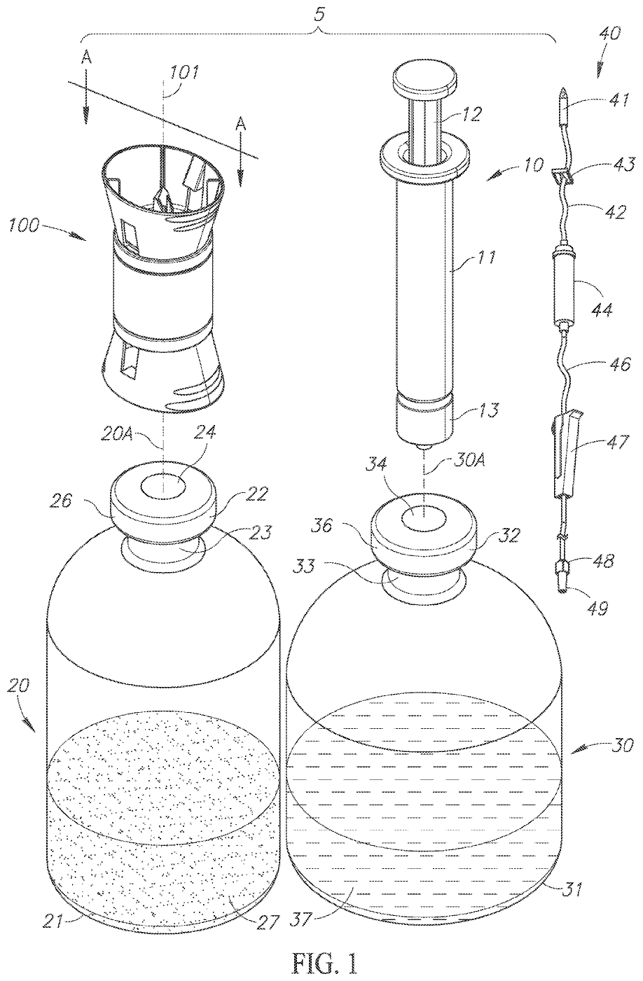

FIG. 1 shows an administration set 5 including an initially empty needleless syringe 10, a drug vial 20, a liquid vial 30, an infusion set 40 (shown in a reduced scale) and a dual vial adapter assemblage 100. The needleless syringe 10 includes a barrel 11 with a plunger 12 and a male Luer lock connector 13. The syringe 10 can be formed with other types of male connectors. The drug vial 20 has a longitudinal drug vial axis 20A and includes an open topped drug vial bottle 21 having a drug vial crown 22 and a narrow diameter drug vial neck 23. The drug vial crown 22 is sealed by a drug vial stopper 24. The drug vial stopper 24 is sealed by an aluminum band 26. The drug vial 20 contains a medicament 27 in the form of a powder, solid or liquid. The liquid vial 30 has a longitudinal liquid vial axis 30A and includes an open topped liquid vial bottle 31 having a liquid vial crown 32 and a narrow diameter drug vial neck 33. The liquid vial crown 32 is sealed by a liquid vial stopper 34. The liquid vial stopper 34 is sealed by an aluminum band 36. The liquid vial 30 includes liquid contents 37 in the form of diluent only or an active component. The IV infusion set 40 includes an IV spike 41, first tubing 42, a clamp 43, a drip chamber 44, second tubing 46, a roller clamp 47, a male Luer connector 48, and a Luer shield 49. First tubing 42 typically have dimensions 4.1 mm×200 mm and second tubing 46 typically have dimensions 4.1 mm×500 mm.

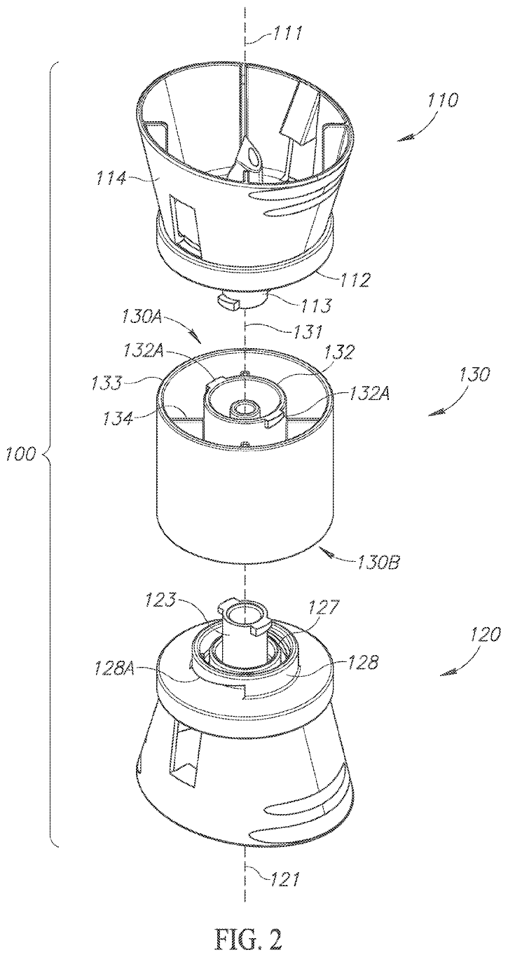

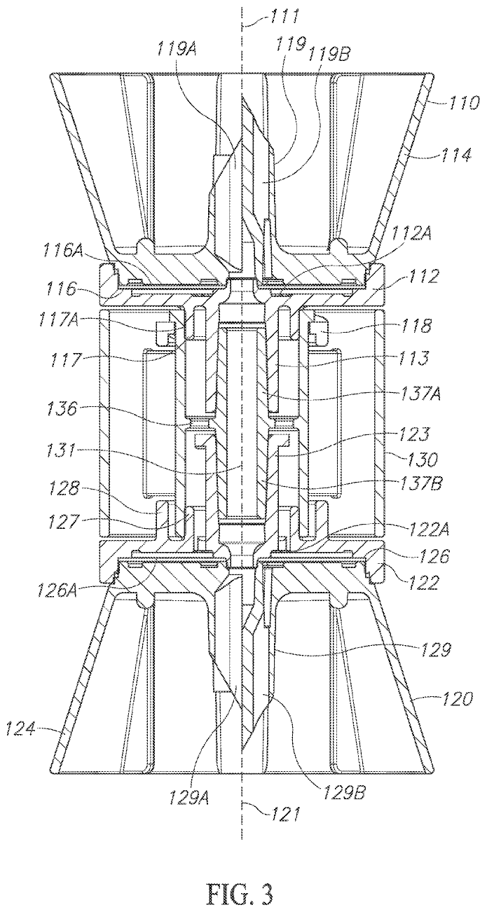

FIG. 2 to FIG. 4 show the dual vial adapter assemblage 100 has a longitudinal dual vial adapter assemblage centerline 101 and includes a triple component construction including a first vented female vial adapter 110 for telescopic mounting on the drug vial 20, a second vented female vial adapter 120 for telescopic mounting on the liquid vial 30 and a tubular liquid transfer coupler 130 for coupling the first vented female vial adapter 110 and the second vented female vial adapter 120.

The first vented female vial adapter 110 has a longitudinal first vented female vial adapter centerline 111 and includes a transverse first vented female vial adapter top wall 112 having an upright first vented female vial adapter female connector 113 and a diametric pair of first vented female vial adapter top wall vents 112A radial outward from the upright first vented female vial adapter female connector 113 relative to the longitudinal first vented female vial adapter centerline 111. The upright first vented female vial adapter female connector 113 is preferably constituted by a female Luer connector including an external screw thread for screw thread engagement by a male Luer lock connector. The first vented female vial adapter 110 includes a first vented female vial adapter skirt 114 for telescopic mounting on the drug vial 20 and an annular air filter cavity 116 disposed between the transverse first vented female vial adapter top wall 112 and the first vented female vial adapter skirt 114. The annular air filter cavity 116 includes an annular air filter 116A.

The first vented female vial adapter top wall 112 includes an interior annular surround 117 radial outward from the diametric pair of first vented female vial adapter top wall vents 112A relative to the longitudinal first vented female vial adapter centerline 111. The first vented female vial adapter top wall 112 includes an exterior annular surround 118 surrounding the interior annual surround 117 and in close proximity thereto for defining an annular groove therebetween. The interior annular surround 117 has an external peripheral sealing surface 117A facing the exterior annular surround 118. The exterior annular surround 118 includes an opposite pair of engagement grooves 118A for engagement purposes. The interior surround 117 and the exterior surround 118 are not necessarily annular but are necessarily radial outward from the diametric pair of first vented female vial adapter top wall vents 112A relative to the longitudinal first vented female vial adapter centerline 111.

The first vented vial adapter skirt 114 includes a first dual lumen vial stopper puncturing cannula 119 for puncturing the drug vial stopper 24 on telescopic mounting the first vented female vial adapter 110 on the drug vial 20. The first dual lumen vial stopper puncturing cannula 119 includes a liquid lumen 119A in flow communication with the first vented female vial adapter connector 113 and an air lumen 119B in flow communication with the diametric pair of vented female vial adapter top wall vents 112A.

The second vented female vial adapter 120 has a longitudinal second vented female vial adapter centerline 121 and includes a transverse second vented female vial adapter top wall 122 having an upright second vented female vial adapter female connector 123 and a diametric pair of second vented female vial adapter top wall vents 122A radial outward from the upright second vented female vial adapter female connector 123 relative to the longitudinal second vented female vial adapter centerline 121. The upright second vented female vial adapter female connector 123 is preferably constituted by a female Luer connector including an external screw thread for screw thread engagement by a male Luer lock connector. The second vented female vial adapter 120 includes a second vented female vial adapter skirt 124 for telescopic mounting on the liquid vial 30 and an annular air filter cavity 126 disposed between the transverse second vented female vial adapter top wall 122 and the second vented female vial adapter skirt 124. The annular air filter cavity 126 includes an annular air filter 126A.

The second vented female vial adapter top wall 122 includes an interior annular surround 127 radial outward from the diametric pair of second vented female vial adapter top wall vents 122A relative to the longitudinal second vented female vial adapter centerline 121 and surrounding the upright second vented female vial adapter female connector 123. The second vented female vial adapter top wall 122 includes an exterior annular surround 128 surrounding the interior annular surround 127 and in close proximity thereto for defining an annular groove therebetween. The interior annular surround 127 has an external peripheral sealing surface 127A facing the exterior annular surround 128. The exterior annular surround 128 includes an opposite pair of engagement grooves 128A. The interior surround 127 and the exterior surround 128 are not necessarily annular but are necessarily radial outward from the diametric pair of first vented female vial adapter top wall vents 122A relative to the longitudinal first vented female vial adapter centerline 121.

The second vented vial adapter skirt 124 includes a second dual lumen vial stopper puncturing cannula 129 for puncturing the liquid vial stopper 34 on telescopic mounting the second vented female vial adapter 120 on the liquid vial 30. The second dual lumen vial stopper puncturing cannula 129 includes a liquid lumen 129A in flow communication with the second vented female vial adapter connector 123 and an air lumen 129B in flow communication with the diametric pair of vented female vial adapter top wall vents 122A.

The first vented female vial adapter 110 and the second vented female vial adapter 120 are preferably of the quick release type as disclosed in PCT International Publication No. WO 2012/150587 entitled Vial Adaptor.

The liquid transfer coupler 130 has a longitudinal liquid transfer coupler centerline 131 and includes a first liquid transfer coupler end 130A for engaging the first vented female vial adapter 110 and a second liquid transfer coupler end 130B for engaging the second vented female vial adapter 120 in a set-up position of the dual vial adapter assemblage 100. The liquid transfer coupler 130 includes an air lumen wall 132 and an external wall 133 mounted on thereon by way of radial vanes 134. The external wall 133 extends between circumferences of the transverse first vented female vial adapter top wall 112 and the transverse second vented female vial adapter top wall 122 for assisting handling of the dual vial adapter assemblage 100. The air lumen wall 132 includes an internal annular transverse flange 136 having an upright first male connector 137A for sealing insertion in the upright first vented female vial adapter female connector 113 and an opposite directed second male connector 137B for sealing insertion in the upright second vented female vial adapter female connector 123.

The air lumen wall 132 has an opposite pair of outward radial directed engagement projections 132A at the liquid transfer coupler end 130A for engagement with the engagement grooves 118A and an opposite pair of outward radial directed engagement projections 132B (not shown) at the liquid transfer coupler end 130B for engagement with the engagement grooves 128A in the set-up position of the dual vial adapter assemblage 100. In the set-up position of the dual vial adapter assemblage 100, the air lumen wall 132 is intended to be slidingly inserted between the interior annular surround 117 and the external annular surround 118 at the first liquid transfer coupler end 130A and the interior annular surround 127 and the external annular surround 128 at the second liquid transfer coupler end 130B. The air lumen wall 132 seals against the external peripheral sealing surface 117A at the first liquid transfer coupler end 130A and the external peripheral sealing surface 127A at the second liquid transfer coupler end 130B.

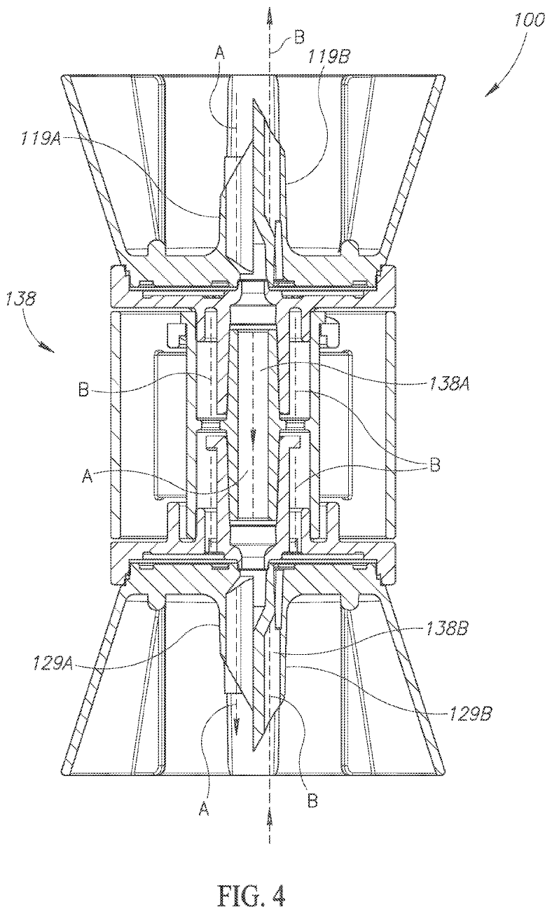

In the set-up position of the dual vial adapter assemblage 100, the liquid transfer coupler 130 simultaneously establishes a dual sealed lumen arrangement 138 including a central sealed liquid lumen 138A between the first vented female vial adapter female connector 113 and the second vented female vial adapter female connector 123 and a sealed air lumen 138B surrounding the liquid lumen 138A for sealed flow communication between the diametric pair of first vented female vial adapter top wall vents 112A and the diametric pair of second vented female vial adapter top wall vents 122A. Accordingly, the dual vial adapter assemblage 100 creates a closed system between a liquid vial and a drug vial for assisting gravitational flow of liquid contents from the liquid vial to the drug vial. FIG. 4 shows gravitational flow of liquid contents from the liquid vial 30 to the drug vial 20 through the sealed liquid lumen 138A denoted by arrow A and venting of air displaced from the drug vial 20 to the liquid vial 30 through the air lumen 119B, the sealed air lumen 138B and the air lumen 129B denoted by arrow B.

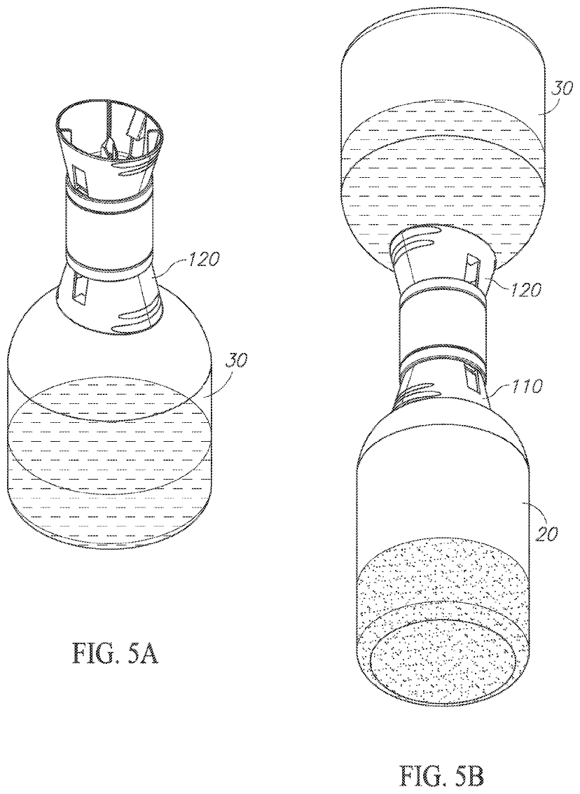

FIG. 5A to FIG. 5F show the use of the administration set 5 for preparing a liquid drug in a drug vial 20 ready for administration to a patient. FIG. 5A shows telescopic mounting the second vented female vial adapter 120 on the liquid vial 30 for puncturing same. FIG. 5B shows inverting the dual vial adapter assemblage 100 together with the attached liquid vial 30 and telescopically mounting the first vented female vial adapter 110 on the drug vial 20 for puncturing same thereby leading to gravitational flow of liquid contents from the liquid vial 30 to the drug vial 20 to form a liquid drug therein and venting of air displaced from the drug vial 20 to the liquid vial 30. FIG. 5C shows unscrewing the liquid transfer coupler 130 from the first vented female vial adapter 110. FIG. 5D shows screwing the syringe 10 onto the first vented female vial adapter 110 for aspirating a liquid drug dosage from the drug vial 20 for administration to a patient. FIG. 5E shows removal of the first vented female vial adapter 110 from the drug vial 20. FIG. 5F shows connection of the IV infusion set 40 to the drug vial 20 for infusion of liquid drug to the patient.

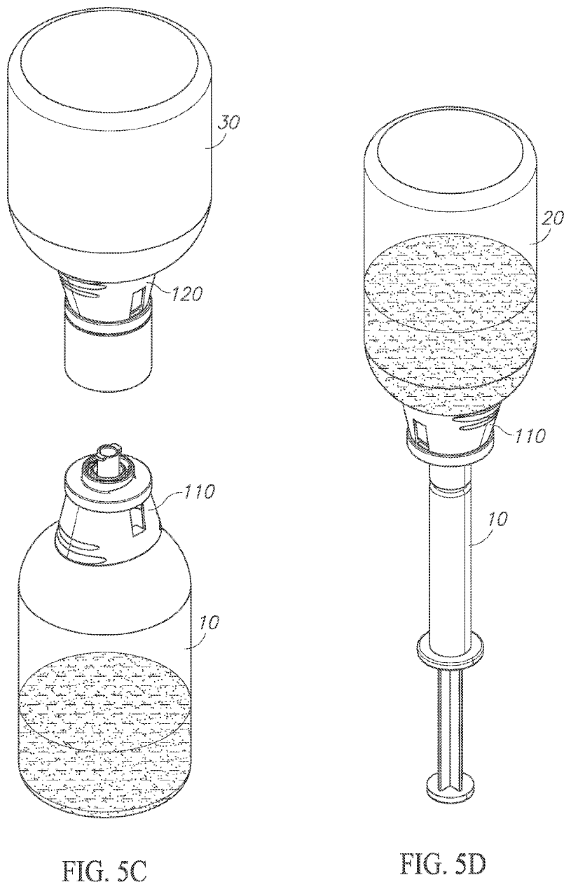

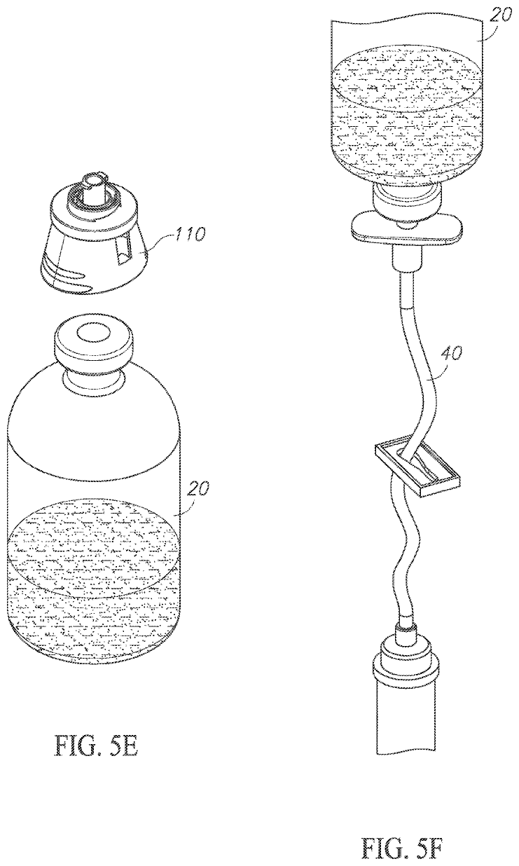

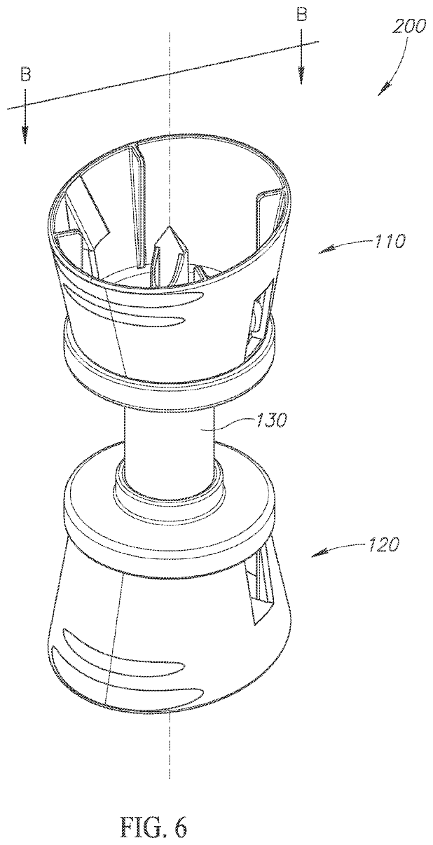

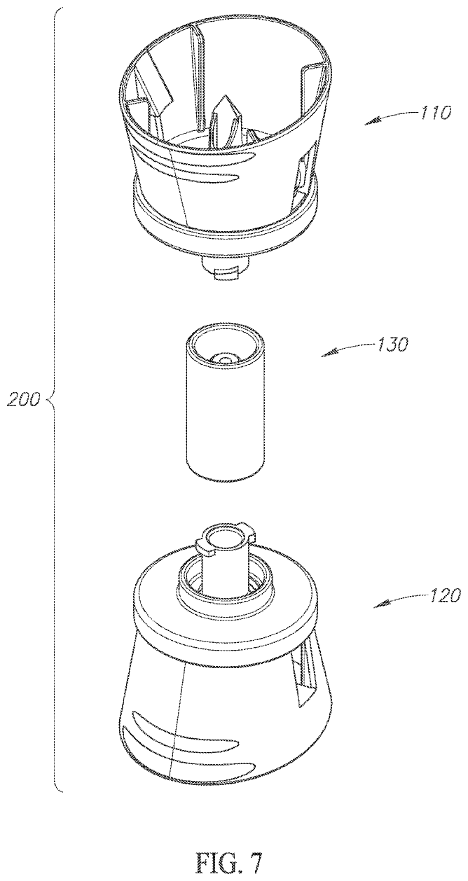

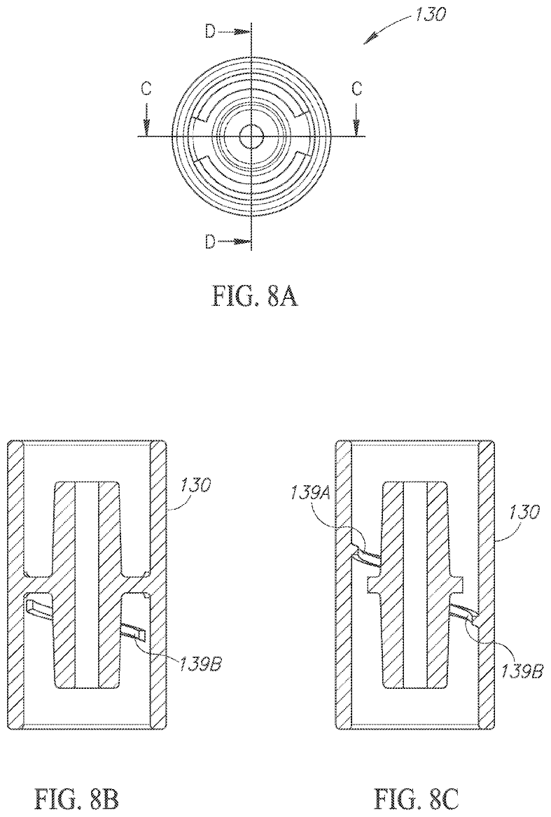

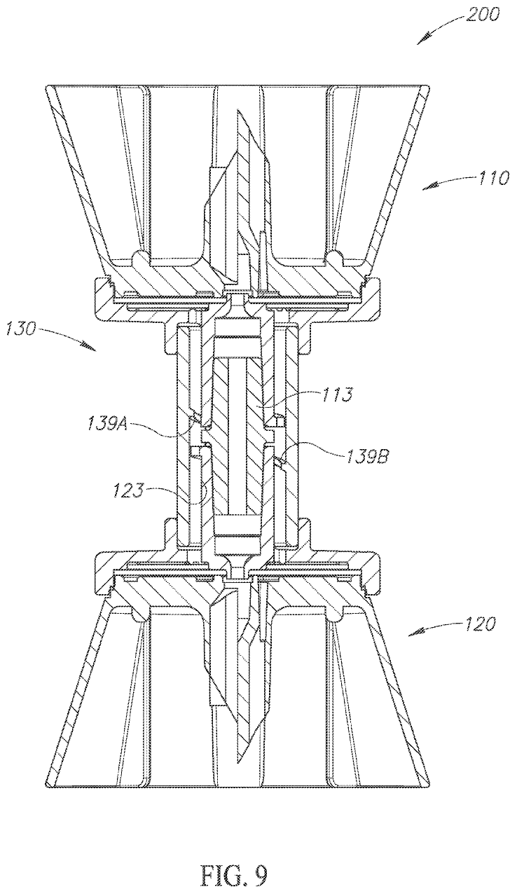

FIG. 6 to FIG. 9 show a dual vial adapter assemblage 200 similar in construction and operation as the dual vial adapter assemblage 100. The latter 200 differs from the former 100 in terms of the engagement of the liquid transfer coupler 130 to the first vented female vial adapter 110 and the second vented female vial adapter 120. Instead of the deployment of the opposite pair of engagement grooves 118A and outward directed engagement projections 132A, and the opposite pair of engagement grooves 128A and outward directed engagement projections 132B, the air lumen wall 132 includes an internal first screw thread 139A for engaging the first vented female vial adapter female connector 113 and an internal second screw thread 139B for engaging the second vented female vial adapter female connector 123.

While particular embodiments of the present invention are illustrated and described, it would be obvious to those skilled in the art that various other changes and modifications can be made without departing from the spirit and scope of the invention.

1. A dual vial adapter assemblage for use with a drug vial and a liquid vial, the drug vial having a drug vial bottle and a drug vial stopper sealing the drug vial bottle, the drug vial containing a medicament, the liquid vial having a liquid vial bottle and a liquid vial stopper sealing the liquid vial bottle, the liquid vial containing liquid contents for mixing with or reconstituting the medicament in the drug vial to form a liquid drug therein, the dual vial adapter assemblage having a longitudinal dual vial adapter assemblage centerline and comprising:
(a) a first vented female vial adapter for telescopic mounting on the drug vial, the first vented female vial adapter having a longitudinal first vented female vial adapter centerline and including:
i) a transverse first vented female vial adapter top wall with an upright first vented female vial adapter female connector and at least one first vented female vial adapter top wall vent radial outward from said upright first vented female vial adapter female connector relative to said longitudinal first vented female vial adapter centerline,
ii) a first vented female vial adapter skirt for telescopic mounting on the drug vial, and
iii) a first dual lumen vial stopper puncturing cannula for puncturing the drug vial stopper on said telescopic mounting said first vented female vial adapter on the drug vial, said first dual lumen vial stopper puncturing member including a first liquid lumen in flow communication with said upright first vented female vial adapter female connector and a first air lumen in flow communication with said at least one first vented female vial adapter top wall vent;
(b) a second vented female vial adapter for telescopic mounting on the liquid vial, the second vented female vial adapter having a longitudinal second vented female vial adapter centerline and including:
i) a transverse second vented female vial adapter top wall with an upright second vented female vial adapter female connector and at least one second vented female vial adapter top wall vent radial outward from said upright second vented female vial adapter female connector relative to said longitudinal second vented female vial adapter centerline,
ii) a second vented female vial adapter skirt for telescopic mounting on the liquid vial, and
iii) a second dual lumen vial stopper puncturing cannula for puncturing the liquid vial stopper on said telescopic mounting said second vented female vial adapter on the liquid vial, said second dual lumen vial stopper puncturing member including a second liquid lumen in flow communication with said upright second vented female vial adapter female connector and a second air lumen in flow communication with said at least one second vented female vial adapter top wall vent; and
(c) a tubular liquid transfer coupler having a longitudinal liquid transfer coupler centerline and including a first liquid transfer coupler end for coupling to said first vented female vial adapter and a second liquid transfer coupler end for coupling to said second vented female vial adapter for establishing a dual sealed lumen arrangement between said first vented female vial adapter and said second vented female vial adapter,
said liquid transfer coupler including a longitudinal air lumen wall for establishing a sealed air lumen of said dual sealed lumen arrangement between said at least one first vented female vial adapter top wall vent and said at least one second vented female vial adapter top wall vent,
said air lumen wall including a first male connector for sealing insertion in said upright first vented female vial adapter female connector and an opposite directed second male connector for sealing insertion in said upright second vented female vial adapter female connector for establishing a central sealed liquid lumen between said first vented female vial adapter female connector and said second vented female vial adapter female connector,
said sealed air lumen being radial outward from said central sealed liquid lumen with respect to said longitudinal liquid transfer coupler centerline,
the dual vial adapter assemblage being such that, in use, telescopic mounting the first vented female vial adapter on the drug vial and the second vented female vial adapter on the liquid vial and placing the liquid vial above the drug vial enables gravitational flow of liquid contents from the liquid vial to the drug vial through said central sealed liquid lumen for forming liquid drug therein and venting of air displaced from the drug vial to the liquid vial through said sealed air lumen and, subsequent detaching of said first vented female vial adapter from said liquid transfer coupler enables attachment of a needleless syringe to said upright first vented female vial adapter female connector for aspiration of liquid contents therefrom.

2. The assemblage according to claim 1 wherein
said first vented female vial adapter top wall includes i) an interior surround radial outward with respect to said at least one first vented female vial adapter top wall vent relative to said longitudinal first vented female vial adapter centerline and surrounding said upright first vented female vial adapter female connector and ii) an exterior surround surrounding said interior surround,
said second vented female vial adapter top wall includes i) an interior surround radial outward with respect to said at least one second vented female vial adapter top wall vent relative to said longitudinal second vented female vial adapter centerline and surrounding said upright second vented female vial adapter female connector and ii) an exterior surround surrounding said interior surround, and
said air lumen wall is sealingly inserted between said first vented female vial adapter top wall's interior surround and exterior surround at said first liquid transfer coupler end and said second vented female vial adapter top wall's interior surround and exterior surround at said second liquid transfer coupler end.

3. The assemblage according to claim 1 wherein said sealed air lumen surrounds said central sealed liquid lumen.

4. The assemblage according to claim 1 wherein said liquid transfer coupler includes an external wall mounted on said air lumen wall for assisting handling the assemblage.

5. The assemblage according to claim 1 wherein said air lumen wall engages said first vented female vial adapter top wall at said first liquid transfer coupler end and said second vented female vial adapter top wall at said second liquid transfer coupler end.

6. The assemblage according to claim 1 wherein said air lumen wall includes an internal first screw thread engaging said first vented female vial adapter female connector and an internal second screw thread for engaging said second vented female vial adapter female connector.
